(19) United States
(12) Patent Application Publication
(10) Pub. No.: US 2019/0196527 A1
(43) Pub. Date: Jun. 27, 2019

(54) MAXIMUM POWER POINT TRACKING CIRCUIT

(71) Applicant: Commissariat à l'Energie Atomique et aux Energies Alternatives, Paris (FR)

(72) Inventor: Dominique BERGOGNE, Saint Didier En Velay (FR)

(21) Appl. No.: 16/221,488

(22) Filed: Dec. 15, 2018

(30) Foreign Application Priority Data
Dec. 21, 2017 (FR) 1762712

(51) Int. Cl. G05F 1/67; H02J 3/38

(52) U.S. Cl. CPC G05F 1/67; H02J 3/385

(57) ABSTRACT

A maximum power point tracking circuit, including a capacitive element coupled in parallel with a power source and controlled by a switch to be periodically integrally discharged towards a power transfer stage, wherein, for each switching cycle of the switch, the latter is turned on at a time which is a function of the charge current of the capacitive element at the previous turning-off of the switch.

### CROSS-REFERENCE TO RELATED APPLICATION

This application claims the priority benefit of French patent application number 17/62712, the content of which is hereby incorporated by reference in its entirety to the maximum extent allowable by law.

### FIELD

The present disclosure generally concerns electronic device and, more particularly, power conversion systems. The present disclosure more specifically relates to maximum power point tracking (MPPT) techniques in a DC/DC conversion system.

### BACKGROUND

Maximum power point tracking circuits are widely used in power conversion systems, particularly DC/DC conversion systems. They can in particular be found in applications of conversion of power originating from batteries, from biofuel cells, etc. A maximum power point tracking circuit is generally used to control a DC/DC converter.

Maximum power point tracking is conventionally managed by digital systems comprising a microcontroller processing measurements of the voltage across the power source and of the current that it supplies. Such systems also most often require a measurement of the power required by the load.

A maximum power point tracking circuit which provides digitizing the current-vs.-voltage characteristic of the power source to then control the switching cycles is known from document WO/2012/090242. This document applies to a power source of photovoltaic panel type.

### SUMMARY

An embodiment decreases all or part of the disadvantages of known maximum power point tracking circuit techniques in power conversion systems.

An embodiment avoids the use of a microcontroller.

Thus, an embodiment provides a maximum power point tracking circuit, comprising a capacitive element coupled in parallel with a power source and controlled by a switch to be periodically integrally discharged towards a power transfer stage, wherein, for each switching cycle of the switch, the latter is turned on at a time which is a function of the charge current of the capacitive element at the previous turning-off of the switch.

According to an embodiment, the turning-on of the switch is caused when information representative of the charge current of the capacitive element reaches a threshold.

According to an embodiment, said threshold corresponds to approximately 20% of the charge current of the capacitive element at the previous turning-off of the switch.

According to an embodiment, the capacitive element is periodically charged up to approximately eighty percent of its maximum charge.

According to an embodiment, the circuit comprises a flip-flop supplying at least one control signal to the power transfer stage.

According to an embodiment, the circuit comprises a first comparator of the current flowing through the capacitive element during charge periods with respect to a threshold.

According to an embodiment, the circuit comprises a second comparator of the voltage across the capacitive element with respect to zero.

According to an embodiment, the capacitive element is coupled in parallel with a series association of a first inductive element of the transfer stage and of a switch.

According to an embodiment, the capacitive element is coupled in parallel with a mixed bridge, a first inductive element of the transfer stage coupling two terminals of the bridge.

An embodiment provides a power transfer system comprising a maximum power point tracking circuit.

According to an embodiment, the system comprises an inductive power transfer stage, controlled by said maximum power point tracking circuit.

An embodiment comprises a maximum power point tracking method, wherein:

a capacitive element, coupled in parallel with a power source, is, at each cycle, integrally discharged by power transfer towards a load;
information representative of the charge current of the capacitive element is measured at the beginning of each charge cycle; and
said information is compared with a threshold to trigger the end of the charge cycle.

According to an embodiment, said capacitive element is periodically charged up to approximately eighty percent of its maximum charge.

### BRIEF DESCRIPTION OF THE DRAWINGS

The foregoing and other features and advantages will be discussed in detail in the following non-limiting description of specific embodiments in connection with the accompanying drawings.

FIG. 1 is a very simplified representation in the form of blocks of an example of a maximum power point tracking power conversion system;

FIG. 2 is a more detailed electric diagram of an embodiment of a maximum power point tracking circuit of FIG. 1;

FIGS. 3A, 3B, and 3C illustrate, in the form of timing diagrams, the operation of the maximum power point tracking circuit;

FIG. 4 is an example of a control stage of a power transfer switch controlled by the circuit of FIG. 2; and

FIG. 5 very schematically and partially shows an embodiment of a maximum power point tracking circuit more particularly adapted to an AC power source.

### DETAILED DESCRIPTION OF THE PRESENT EMBODIMENTS

The same elements have been designated with the same reference numerals in the different drawings.

For clarity, only those steps and elements which are useful to the understanding of the embodiments which will be described have been shown and will be detailed. In particular, the power source connected upstream of the maximum power point tracking circuit as well as the load coupled downstream of this circuit have not been detailed, the described embodiments being compatible with usual sources and loads for which a maximum power point tracking circuit is desired to be used.

Throughout the present disclosure, the term “connected” is used to designate a direct electrical connection between circuit elements, whereas the term “coupled” is used to designate an electrical connection between circuit elements that may be direct, or may be via one or more intermediate elements.

The terms “approximately”, “about”, and “in the order of” are used herein to designate a tolerance of plus or minus 10%, preferably of plus or minus 5%, of the value in question.

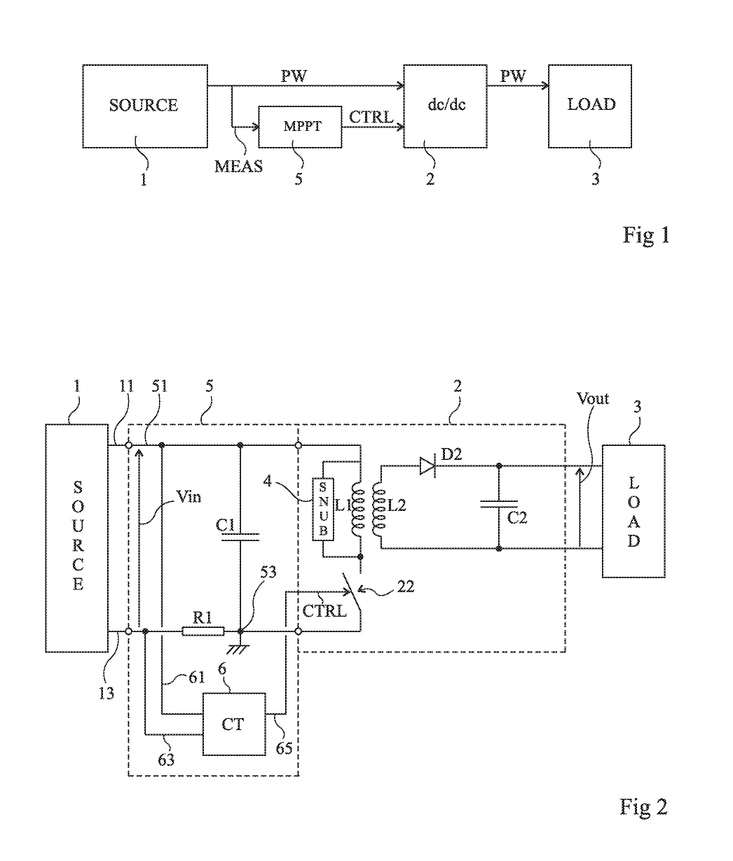

FIG. 1 is a very simplified representation in the form of blocks of an example of a maximum power point tracking power conversion system of the type to which the embodiments which will be described apply as an example.

Such a system uses a power conversion chain comprising a power source (SOURCE) 1, a transfer or power conversion stage 2, for example, DC/DC, and a load 3 (LOAD). A maximum power point tracking circuit (MPPT) circuit 5 is interposed between power source 1 and conversion stage 2. Power PW transits from the power source to conversion stage 2. Stage 2 is controlled (signal(s) CTRL) by maximum power point tracking circuit 5, which processes one or a plurality of measurements MEAS performed at the input (on the power source side).

Load 3 may be of any type and may be formed of various additional power conversion stages.

Power source 1 is preferably essentially resistive, that is, it has a significant internal resistance or, in other words, it is capable of withstanding a shorting with no destruction. It may be a battery, a biofuel cell, etc. In particular, although a DC power source is mainly taken as an example hereafter, the described embodiments also apply to an AC power source, as specified hereafter.

In most usual systems, a capacitor for smoothing the voltage supplied by the power source is used between power source 1 and conversion stage 2. The capacitor is sized according to the characteristics of the load and of the power source so that it is never discharged and to avoid losing its input voltage smoothing function. A usual maximum power point tracking circuit then generally uses a measurement of the off-load voltage of the power source. This generates constraints such as the need for a switch to disconnect the power source from the rest of the system and allow such an off-load measurement.

The described embodiments originate from a novel analysis of the possible operation of a maximum power point tracking. In particular, the needs of the load are not taken into account to perform any control and only the power source and its possible variations are considered, to always supply the load, via transfer stage 2, with the maximum possible power.

FIG. 2 shows an electric diagram of an embodiment of a maximum power point tracking circuit 5, associated with a power transfer stage 2 of DC/DC converter type.

Two terminals 51 and 53 of maximum power point tracking circuit 5 are coupled to two terminals 11 and 13 of power source 1 supplying, in the present example, a DC voltage Vin, terminal 53 representing the ground. A capacitor C1 is connected to terminals 51 and 53. For example, terminal 51 is connected to terminal 11 while terminal 53 is coupled, by a current measurement device (for example, a current-to-voltage resistor R1), to terminal 13.

Terminals 51 and 53 are connected in parallel to a series association of a first inductive element L1 and of a switch 22 of stage 2. The terminals of inductance L1 are preferably coupled by a circuit 4 for attenuating parasitic oscillations (SNUB). Such a circuit 4 is generally formed of a diode having its anode coupled by a resistor to a terminal (that connected to switch 22) of inductance L1 and having its cathode coupled, by a capacitor in parallel with a resistor, to the other terminal of inductance L1 (that connected to terminal 11). Inductive element L1 is coupled to a second inductive element L2 forming the secondary of transfer stage 2. Inductive element L2 is connected across a series association of a rectifying element, for example, a diode D2, and of a capacitor C2. Capacitor C2 supplies, in the present example, a DC voltage Vout to load 3. The function of capacitor C2 is to smooth the voltage recovered across the secondary of transformer L1/L2.

Switch 22 of stage 2 is controlled by a control stage 6 (CT) of circuit 5 so that capacitor C1 is charged to a certain level, and then that the power is transferred to inductance L1, and then integrally transferred to the secondary of converter 2. Two input terminals 61 and 63 of stage 6 are respectively connected to terminals 51 and 13 and an output terminal 65 supplies control signal CTRL of switch 22. Terminals 61 and 63 are coupled to measurement elements of stage 6. In particular, the information sampled form terminal 61 enables to determine when the voltage across capacitor C1 becomes zero and when the capacitor is thus fully discharged. The information sampled from terminal 63 enables, due to resistor R1 forming a voltage-to-current converter, to measure information representative of the current supplied by source 1.

The system shown in FIG. 2 operates as follows. When the power stored in capacitor C1 is sufficient, switch 22 is turned on and this power is transferred to inductance L1 as in a resonant circuit. When the power transfer to inductance L1 is over, capacitor C1 is fully discharged and the voltage thereacross is zero. The voltage across power source 1 is then also approximately zero (neglecting resistance R1). Switch 22 is then turned off, which causes a transfer of the power stored in inductance L1 to the secondary (inductance L2) in order to be supplied to load 1, the voltage being rectified by diode D2 and smoothed by capacitor C2. At the same time, such a turning-off of switch 22 starts a new charge cycle of capacitor C1.

The turning-off of switch 22 is performed with no switching loss since it is performed while the voltage across capacitor C1 is zero and the current in inductance L1 is also zero.

The “sufficient” criterion of the power stored in the capacitor forms part of the maximum power point tracking. It is considered that by authorizing a periodic full discharge of capacitor C1, the fact of initiating the discharge while the capacitor is at approximately 80% of its maximum charge (voltage) enables to impose, at the output of power source 1, a voltage of average value Vin/2, which is an optimum in terms of power transfer. The maximum charge of the capacitor corresponds to a voltage thereacross corresponding to voltage Vin (neglecting the voltage drop in resistor R1).

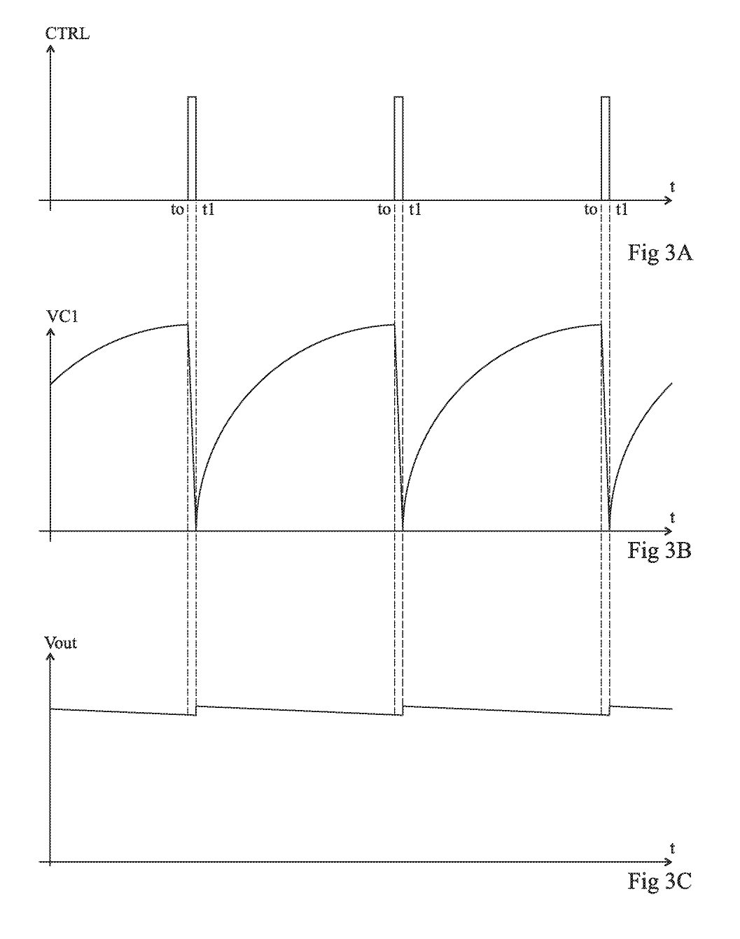

FIGS. 3A, 3B, and 3C illustrate in timing diagrams the operation of maximum power point tracking circuit 5 of FIG. 2. A steady state is considered.

FIG. 3A shows an example of shape of control signal CTRL of switch 22. A MOS transistor controlled in all or nothing is for example considered. FIG. 3B illustrates an example of corresponding shape of voltage VC1 across capacitor C1. FIG. 3C shows an example of corresponding shape of output voltage Vout across capacitor C2.

At each time t1 of turning-off of switch 22, capacitor C1 starts a charge cycle. The charge of capacitor C1 has an approximately exponential shape. For this purpose, it is considered to be in the presence of a mainly resistive power source having a negligible inductance as compared with its series resistance. This is in practice true for batteries, biofuel cells, etc. When (time t0) the charge of capacitor C1 reaches approximately 80% of its maximum charge (voltage) (80% of Vin), stage 6 causes the turning-on of switch 22 for the time necessary to transfer the power stored in capacitor C1 to inductance L1. As soon as the voltage across capacitor C1 becomes zero, stage 6 causes the turning-off of switch 22 to initiate a new charge cycle of capacitor C1. On the side of voltage Vout (FIG. 3C), the voltage slightly rises for each power transfer.

The obtaining of the control signal from a detection of the fact that the voltage across capacitor C1 has become zero and of the time when it reaches 80% of its maximum charge (voltage) may take different forms.

The principle is to estimate the charge current of capacitor C1 at the beginning of the charge, that is, at the turning-off (t1) of switch 22, to then turn-on this switch (t0) when the current no longer corresponds to more than 20% of the value at the beginning of the charge. Indeed, the beginning of the charge of capacitor C1 occurs under a maximum current and this current then decreases exponentially. Considering that power source 1 has an essentially resistive impedance, the voltage across capacitor C1 reaches approximately 80% of voltage Vin when the current corresponds to no more than approximately 20% of the maximum current (at the beginning of charge cycle t1). Thus, by measuring, each time switch 22 is turned off, the initial charge current of capacitor C1, its turning on can be easily caused when the charge voltage reaches 80% of its maximum value. Indeed, it is sufficient to determine the time when the charge current corresponds to no more than 20%, preferably 20%, of the measured initial value (dividing by five the measured value). This enables to guarantee a charge to approximately 80% of the maximum voltage at each cycle without needing to know the off-load voltage of the power source.

According to an embodiment, digital microcontroller-type means processing, at each cycle, the measurement of the current at time t1 when switch 22 is turned off to determine the time at which it should be turned on are used.

According to another preferred embodiment, analog comparators associated with a flip-flop to generate control signal CTRL are used.

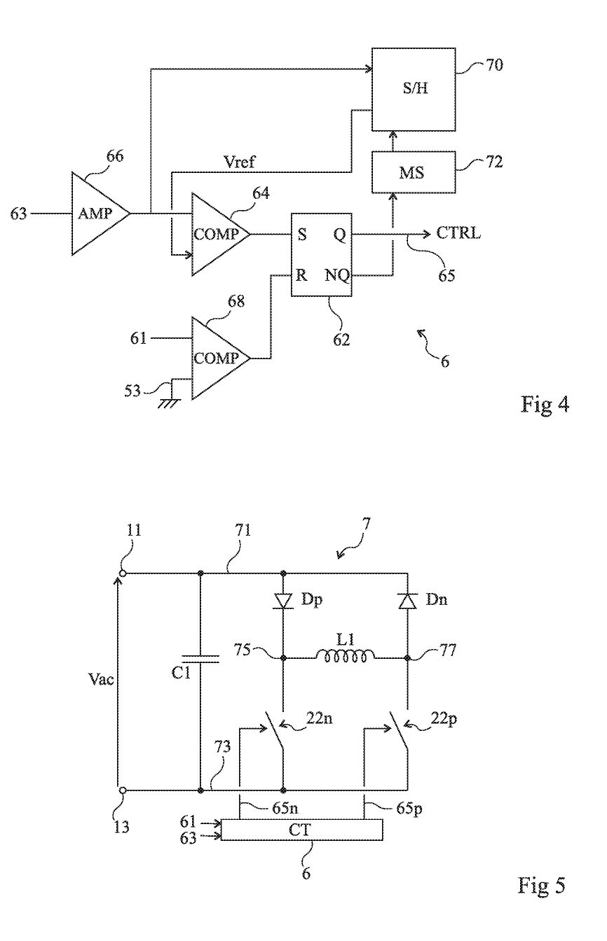

FIG. 4 schematically shows an example of a stage 6 according to this embodiment.

A flip-flop 62, for example, of RS type, supplies via its direct output Q, control signal CTRL of switch 22. The case of a switch 22 controlled to be turned on by a signal CTRL in the high state is considered. A set input S of flip-flop 62 receives information representative of the charge current of capacitor C1 with respect to a reference level Vref. This information is for example provided by a comparator 64 (COMP) having an input coupled, preferably via an amplifier 66 (AMP), to terminal 63 and thus receiving information representative of the voltage across resistor R1, which is proportional to the current in capacitor C1 during charge cycles. A reset input R of flip-flop 62 receives information representative of the fact that voltage VC1 has become zero (time t1) across capacitor C1. This information is for example provided by a comparator 68 (COMP) having a first input coupled to terminal 61 and having a second input connected to ground 53. Flip-flop 62 is thus reset (and switch 22 is thus turned off) each time voltage VC1 becomes zero. Signal CTRL remains in the low state as long as set input S of flip-flop 62 does not switch to the high state, that is, as long as the current in capacitor C1 does not reach a value conditioned by the value of reference voltage Vref.

In order for switching point t0 to always correspond (for each cycle) to 80% of the maximum charge, stage 6 comprises a sample-and-hold circuit 70 (S/H) triggered by the turning-off of switch 22 (output of amplifier 66). Such a triggering may be direct but is preferably obtained by a monostable (MS) circuit 72 having a trigger input connected to inverted input NQ of flip-flop 62. Monostable circuit 72 triggers sample-and-hold circuit 70. Sample-and-hold circuit 70 supplies reference level Vref, corresponding to 20% of the value of the current measured at the beginning of the charge cycle at comparator 64. The comparison of the information representative of the charge current of capacitor C1 with threshold Vref corresponding to 20% of the initial charge current (and thus 80% of the maximum charge voltage reached at the previous cycle) is thus performed during the entire charge cycle.

The described circuit adapts to variations of the off-load voltage of the power source, which enable to modify the supplied power without modifying the maximum power point. When the DC voltage supplied by the power source varies, this results in a variation of the average value of the voltage across capacitor C1 (which increases if voltage Vin increases) and in a larger discharge current in inductance L1. Independently from the frequency of the turn-on pulses of switch 22, the average value of the voltage across capacitor C1 will follow the variation of the off-load voltage to remain at approximately half thereof.

The described circuit also adapts to variations of the internal resistance of the power source to preserve a maximum power point. To achieve this, the frequency of the control pulses of the switch varies to keep an average value of voltage VC1 across capacitor C1 at approximately half the off-load voltage of the power source.

Although this has not been illustrated, an auxiliary power source supplies a power supply voltage to stage 6. The power source for example extracts the power necessary for its operation from source 1 or from an auxiliary capacitor in series with a diode across capacitor C1.

FIG. 5 very schematically and partially shows an embodiment of a maximum power point tracking circuit more particularly adapted to an AC power source.

This embodiment is based on the use of a mixed bridge 7 having two AC input terminals 71 and 73 respectively coupled to terminals 11 and 13 to which source 1 (not shown) supplies an AC voltage Vac. Two rectified output terminals 75 and 77 of bridge 7 receive the terminals of inductive element L1. Two switches 22n and 22p couple terminal 73 respectively to terminals 75 and 77. Two diodes Dp and Dn couple terminal 71 respectively to terminals 75 and 77, the anode of diode Dp being on the side of terminal 71 and the anode of diode Dn being on the side of terminal 13. Switches 22p and 22n are controlled, respectively during positive and negative halfwaves of voltage Vac, by signals 65p and 65n originating from circuit 6. During positive halfwaves of AC voltage Vac, a current flows from terminal 11, through diode Dp, through inductance L1 and through switch 22p (when it is on). During negative halfwaves of voltage Vac, a current flows from terminal 13, through switch 22n (when on), through inductance L1, and through diode Dn. For simplification, the rest of the assembly, particularly the secondary of the inductive transformer, has not been shown in FIG. 5. It is identical to that of FIG. 2.

As a variation, a rectifying bridge is interposed be-tween terminal 13 of FIG. 2 and resistor R1 (it is preferred to perform the rectification on the side of terminal 13 rather than on the side of terminal 11 so that the current measurement is also performed on a rectified voltage).

An advantage of the described embodiments is that they allow a power transfer at the maximum power point of a power source which adapts to voltage and impedance variations of the power source.

Another advantage of the described embodiments is that they are compatible with an embodiment with no microcontroller.

Various embodiments have been described. Various modifications will occur to those skilled in the art. In particular, the sizing of the different circuit components depends on the application and on the power range for which the system is intended. Further, the practical implementation of the embodiments which have been described is within the abilities of those skilled in the art based on the functional indications given hereabove.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A maximum power point tracking circuit, comprising a capacitive element coupled in parallel with a power source and controlled by a switch to be periodically integrally discharged towards a power transfer stage, wherein, for each switching cycle of the switch, the latter is turned on at a time which is a function of the charge current of the capacitive element at the previous turning-off of the switch.

2. The circuit of claim 1, wherein the turning-on of the switch is caused when information representative of the charge current of the capacitive element reaches a threshold.

3. The circuit of claim 2, wherein said threshold corresponds to approximately 20% of the charge current of the capacitive element at the previous turning-off of the switch.

4. The circuit of claim 1, wherein the capacitive element is periodically charged to approximately eighty percent of its maximum charge voltage.

5. The circuit of claim 1, comprising a flip-flop for supplying at least one control signal to the power transfer state.

6. The circuit of claim 5, comprising a first comparator of the current flowing through the capacitive element during charge periods with respect to a threshold.

7. The circuit of claim 6, comprising a second comparator of the voltage across the capacitive element with respect to zero.

8. The circuit of claim 1, wherein the capacitive element is coupled in parallel with a series association of a first inductive element of the transfer state with a switch.

9. The circuit of claim 1, wherein the capacitive element is coupled in parallel with a mixed bridge, a first inductive element of the transfer stage coupling two terminals of the bridge.

10. A power transfer system comprising the circuit of claim 1.

11. The system of claim 10, comprising an inductive power transfer stage, controlled by said circuit.

12. A maximum power point tracking method, wherein:
a capacitive element, coupled in parallel with a power source, is, at each cycle, integrally discharged by power transfer towards a load;
information representative of the charge current of the capacitive element is measured at the beginning of each charge cycle; and
said information is compared with a threshold to trigger the end of the charge cycle.

13. The method of claim 12, wherein said threshold corresponds to approximately 20% of the current at the beginning of the charge cycle.

14. The method of claim 12, wherein said capacitive element is periodically charged to approximately eighty percent of its maximum charge.
